(19) United States
(12) Patent Application Publication
(10) Pub. No.: US 2008/0020930 A1
(43) Pub. Date: Jan. 24, 2008

(54) Bulk Spiked Sorbent Tubes

(76) Inventor: Linda S. Coyne, Pittsburgh, PA (US)

Correspondence Address: Beck & Thomas, P.C.;SUITE 100, 1575 McFARLAND ROAD, PITTSBURGH, PA, 15216-1808, US

(21) Appl. No.: 11/776,604

(22) Filed: Jul. 12, 2007

Related U.S. Application Data
(60) Provisional application No. 60/820,095, filed on Jul. 21, 2006.

(51) Int. Cl. C01B 31/08

(52) U.S. Cl. 502/416

(57) ABSTRACT

This invention is a method for making a spiked sorbent in bulk and a spiked sorbent tube. The sorbent is spiked prior to being inside of the tube.

### CROSS REFERENCE TO RELATED APPLICATION

This Application claims the benefit of U.S. Provisional Application No. 60/820,095, filed Jul. 21, 2006. U.S. Provisional Application No. 60/820,095 is herein incorporated by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### BACKGROUND OF THE INVENTION

(1) Field of the Invention

This invention relates to spiked sorbent tubes.

(2) Description of Related Art

Samples of hazardous gases and vapors in air are collected in sorbent tubes. Sorbent tubes were developed for testing the air quality for workers.

Sorbent tubes are made out of glass. The tube contains various types of solid adsorbent material (sorbents). Examples of sorbents include activated charcoal, silica gel, and organic porous polymers such as TENAX® and AMERLITE® XAD resins. Sorbents are selected for sampling specific compounds in using the following criteria:
(1) ability to trap and retain the compound(s) of interest even in the presence of other compounds;
(2) whether or not the sorbent alters the compound(s) of interest; and
(3) the ability to allow collected compounds to be easily desorbed or extracted for analysis.

Sorbent tubes are attached to air sampling pumps for sample collection. A pump with a calibrated flow rate in ml/min is normally placed on a worker's belt and it draws a known volume of air through the sorbent tube. Alternatively, pumps and sorbent tubes are placed in areas for fixed-point sampling. Chemicals are trapped onto the sorbent material throughout the sampling period.

Media containing known quantities of chemicals have been used for years when analyzing sorbent tubes. They are sometimes referred to as “spikes” and are used for quality control programs in many areas, including process control, environmental and industrial hygiene.

Some of the techniques that have been used to generate these known quantities include: 1) certified cylinders; 2) syringe pumps; 3) permeation tubes; 4) direct injection; and 5) bags, to name a few. Each of these techniques requires additional equipment to deliver chemical to the media because media is contained in sorbent tubes. This requires careful calibration of many of the parts and accessories.

Some of the techniques listed above, specifically 4 and 5, are highly dependent on the analytical techniques of the operator. In addition, the equipment used in these spiking techniques can be very expensive.

When these techniques are used to generate spikes, the sample must be destroyed in order to analyze the spike level and determine whether the proper level was attained for the purposes. Usually personnel rely on the theoretical calculations based on air flow, density and other parameters to determine the level spiked on the tube or media. But because there can be so many variables used to calculate this theoretical, many times when the spike is analyzed, the results do not reflect the theoretical level. Some agencies, such as the EPA, require that spiked levels be within certain percentages during monitoring studies. If they are not, the whole study must be redone. These studies can cost in the range of tens of thousands of dollars in labor, equipment and analysis costs.

U.S. Pat. No. 5,661,224 to Walsh describes prior art methods for spiking sorbent tubes. The teachings of U.S. Pat. No. 5,661,224 are incorporated by reference.

### BRIEF SUMMARY OF THE INVENTION

The inventor describes a technique to deliver chemicals and/or metals in solutions to various media such as activated carbons. The technique involves the addition of the chemical in a solution to bulk sorbent using a rotary evaporator. If the chemical is added in a solution, the spiked sorbent is heated while it is dispersing the chemical and at the same time driving off any residual solvent. The chemical can also be added (liquid or vapor) with no solvent and with no water bath (at room temperature). After the sorbent is dry and free flowing, it is analyzed as a bulk material and certified. This material can then simply be added to a tube as a “spike”. It can also be used as a reference standard as a bulk material. The technique has been found to be accurate and precise as is illustrated in the tables of data.

The steps used in preparing this bulk are minimal which reduces the chance of errors. In addition, it is analyzed and certified so any errors would be documented.

The other unique property of this invention is that once a “bulk spike” is prepared with activated carbon, new bulk levels can be prepared be simply taking a sample of the bulk spike and diluting it with varying amounts of activated carbon or the blank media on which it was originally spiked. This can be certified as well and is less prone to errors than even the original bulk spike. If any problems are found during the Quality Control, another sample can be obtained since the original bulk sample exists. This is not possible with any other spiking technique.

The bulk spiked sorbent is used primarily for quality control purposes. A chemical is added to the sorbent. The chemical that was coated on the sorbent is analyzed. The coating (spiked) is not used in any way to stabilize a compound as in treated sorbents. The primary use of this is not to collect an air sample, as in treated sorbents, but to check the accuracy of the method and the analyst.

This invention provides a method for making a spiked sorbent tube. The following are provided:

1) a sorbent;

2) a tube; and

3) a substance.

The substance is spiked on the sorbent. The sorbent is then added to the tube. The sorbent and the substance can be provided in bulk. The desired concentration for the spiked sorbent can be controlled by selecting the appropriate amount of the spiked sorbent and then adding additional sorbent to obtain the appropriate amount of sorbent to obtain the desired concentration of the spike sorbent. A second substance can be spiked onto the sorbent. The spiked sorbent can be a PCB activated carbon. The sorbent can be potassium iodide treated active carbon. The substance can be elemental mercury or a VOC. The VOC's can be aromatic hydrocarbons, aliphatic hydrocarbons, chlorinated hydrocarbons, esters, acetates, ethers and aldehydes.

The sorbent could also be silica gel, XAD resins, Chromosorb resins, Porapak resins, Hayesep resins, TENAX® TA, TENAX GR, carbon molecular sieves, molecular sieves, beaded carbons, and FLORISIL.

The same spiked sorbent can also be used in multiple tubes. The sorbent is spiked outside of a tube.

### BRIEF SUMMARY OF THE INVENTION

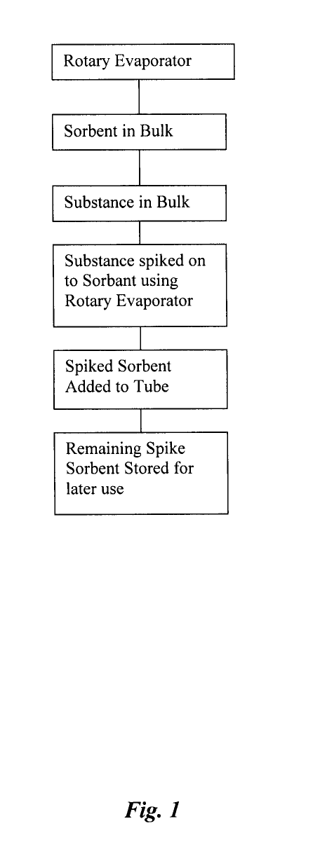

FIG. 1 is a block diagram of the process of spiking a sorbent.

### DETAILED DESCRIPTION OF THE INVENTION

### Definitions

“a spiked sorbent tube”—a tube having media that contains a known amount of a chemical.

“providing a sorbent”—supplying something that will hold a desired chemical substance.

“providing a tube”—supplying a tube.

“providing a substance”—supplying something that the sorbent is testing for, typically a chemical.

“spiking the substance on the sorbent”—putting an amount of a chemical onto the sorbent. This can be can be accomplished by any method or apparatus. A preferred way to do this is to use a rotary evaporator. The chemical added to the sorbent can be in liquid or gaseous form.

“adding the spiked sorbent to the tube to create a spiked sorbent tube”—placing the spiked sorbent into the tube in any way. There are traditional ways known in the art how to place the sorbent into the tube.

“provided in bulk”—supplied in large quantities.

“determining a desired concentration for the spiked sorbent”—picking a known quantity of the substance or chemical that is going to be placed on the sorbent.

“selecting a desired amount of the spiked sorbent”—picking a quantity of spiked sorbent.

“adding additional sorbent to obtain the desired concentration of the spiked sorbent”—introducing more of the sorbent to the spiked sorbent. This can be done, for example, to have a lower concentration for spiked sorbent.

“providing a second substance that can be spiked onto the sorbent”—supplying another chemical that can be placed onto the sorbent.

“VOC”—a volatile organic compound. A wide range of carbon-based molecules, such as aldehydes, ketones and hydrocarbons are examples of VOCs.

“adding a portion of the spiked sorbent to a first tube”—introducing some of the spiked sorbent to a tube.

“adding a second portion of the spiked sorbent to a second tube”—introduce an additional portion to a second tube.

“spiking the sorbent with the substance outside of the tube”—adding the chemical to the sorbent when the sorbent is not within the tube.

“TENAX TA” is a trademark for a product that is a porous polymer resin based on 2.6-diphenylene oxide. It has been specifically designed for the trapping of volatiles and semi-volatiles from air or which have been purged from liquid or solid sample matrices. Both the EPA and NIOSH specify the use of Tenax in their standard methods. Properties: Chemical Structure or Name: 2,6-diphenylene-oxide polymer resin; Temperature Limit: 350° C.; Affinity for Water: low; Specific Surface Area: 35 sq. m/g; Pore Volume: 2.4 cc/g; Average Pore Size: 200 nm; Density: 0.25 g/cc; Mesh size: 60/80 mesh

“TENAX GR” is a trademark a for a product that is a composite material of Tenax TA and 30% graphite. The resulting material gives a higher breakthrough volume for most volatile organics, yet still has a low affinity for water. In addition Tenax™ GR maintains its high temperature stability to 350 degrees C. These properties make Tenax™ GR an ideal adsorbent for the trapping of volatiles from air, water and solid samples. Properties: Chemical Structure or Name: 2,6-diphenylene-oxide polymer resin plus 30% graphite; Temperature Limit: 350 degrees C.; Affinity for Water: low; Specific Surface Area: 24.1 sq. m/g; Pore Volume: 2.4 cc/g; Average Pore Size: 200 nm; Density: 0.55 g/cc; Mesh size: 60/80 mesh.

“FLORISIL” is a trademark for a product that is hard powdered magnesium-silica gel that is a highly selective adsorbent.

### Description

To start the preparation of the bulk spiked sorbent, a Rotary Evaporator is assembled as shown in FIG. 1. It consists of the condenser (cooled with water), the condensing flask, the receiving flask, a water bath, a ServoJack drive and Teflon tubing.

To start the preparation of the bulk spiked sorbent, a known amount of media, such as charcoal, is placed in the receiving flask. A known volume of the “spike” chemical is then added to this media. The receiving flask is then attached to the ServoJack drive which controls the rotation of this flask and also raises and lowers the flask, in and out of the bath. Not all spiked material is lowered into the water bath as discussed earlier. The water is turned on to the condenser; also at this time, the nitrogen flow is turned on such that there is flow into the receiving flask. An appropriate flow is usually at 1 liter per minute but can be any flow which allows for proper coating of the chemical onto the media. The evaporating flask is also attached at this point to collect any solvent which may be driven off of the media. The receiving flask can then be lowered into the water bath at whatever temperature is specified. Sometimes the receiving flask is not placed in the water bath. The bath temperature can range from 30° to 100° c. Different temperatures would be used for different chemicals and applications. The ServoJack drive is engaged such that the flask begins to rotate, so that a uniform coating can be achieved. The RPM for most studies is 70 rpm, but is not limited to this speed. In most cases, the process can range from 30 minutes to 2 hours, but is not limited to this range.

The data is found in Tables 1 through 3. The data includes recoveries and precision between batches for 8 VOCs, 2 month storage data in the refrigerator for the 8 VOCs, and recovery data for methylene chloride by using dilution of bulk sorbent.

This method of making bulk spike sorbent allows for multiple tubes to be produced. The tubes can even be produced at a later date because of problems during quality control.

TABLE 1
Recovery and Precision Data for 8 VOCs Spiked in Bulk
onto Activated Carbon

| Compound | Level Spiked (μg) | % Recovery +/− RSD |
|---|---|---|
| Hexane-Run 1 | 4488 | 105.5 +/− 4.2 |
| Hexane-Run 2 | 4488 | 101.5 +/− 3.3 |
| Ethyl acetate-Run 1 | 7216 | 102.9 +/− 2.0 |
| Ethyl acetate-Run 2 | 7216 | 97.2 +/− 1.5 |
| Methylene chloride Run 1 | 2121 | 99.3 +/− 3.3 |
| Methylene chloride Run 2 | 2121 | 106.1 +/− 6.7 |
| Benzene | 1758 | 105.8 +/− 4.6 |
| Benzene-Run 2 | 1758 | 107.0 +/− 12.9 |
| Trichlorethylene-Run 1 | 1464 | 119.1 +/− 7.8 |
| Trichlorethylene-Run 2 | 1464 | 102.3 +/− 3.9 |
| Toluene-Run 1 | 1734 | 107.1 +/− 6.9 |
| Toluene-Run 2 | 1734 | 105.5 +/− 15.7 |
| Butyl acetate-Run 1 | 3530 | 111.2 +/− 4.2 |
| o-Xylene-Run 1 | 1760 | 108.4 +/− 7.8 |
| o-Xylene-Run 2 | 1760 | 101.9 +/− 12.5 |

TABLE 2
Storage of Bulk Spiked Sorbent
For 2 months in the Refrigerator

| Compound | % Recovery |
|---|---|
| Hexane | 105.7 |
| Ethyl acetate | 99.2 |
| Methylene chloride | 105.2 |
| Benzene | 97.7 |
| Trichloroethylene | 106.8 |
| Toluene | 100.4 |
| Butyl acetate | 103.3 |
| o-Xylene | 94.9 |

### All recoveries should range between 90 and 110% recovery.

TABLE 3
Bulk Sorbent with Methylene Chloride:
Prepared by Dilution Method
Target level: 212.1 μg/100 mgs

| Sample | % Recovery |
|---|---|
| Bulk-1 | 112.7 |
| Bulk-2 | 91.4 |
| Bulk-3 | 103.1 |
| Bulk-4 | 101.5 |
| Bulk-5 | 122.5 |
| Average | 106.2% |
| Std. Dev. | 11.8 |

This sample was prepared by taking 2 grams of the original bulk spike at 2121 ug/100 milligrams and diluting this with 18 grams of the activated carbon. Then five 100 mg samples were taken from this diluted bulk and analyzed. As you can see, the results are showing 106% recovery, indicating that the dilution technique of 1:10 works.

An example for making a spiked bulk sorbent of Toluene at 1734 ug can be made as follows:
1. Weigh out 25 grams of activated carbon and place in a rotary evaporator receiving flask;
2. Add 0.5 mL of toluene to the flask containing the carbon using a volumetric pipet;
3. Attach to the Rotary Evaporator and rotate at 70 RPM for one hour (the sorbent should appear dry and free flowing; and
4. Transfer to amber jar and store in freezer.

An Example for making elemental Mercury bulk spike 32,000 ng/gram sorbent is as follows:
1. Take 25 grams of KI treated charcoal and add to Rotary evaporator receiving flask;
2. Add 100 mL of Optima Methanol to sorbent and swirl to wet the media;
3. Prepare a 3% Stannous Chloride solution by weighing out 15 grams of stannous chloride into a beaker. Transfer contents from beaker to a 500 mL volumetric flask. Fill half way with DIUF water and mix. Add 25 mL of concentrated hydrochloric acid and mix again. Fill to 500 mL mark with DIUF water. Mix gently.
4. Add 8 mL of AccuStandard Mercury solution, CLP-CAL-06-1 to a 10 mL beaker;
5. Add 100 microliters of 3% Stannous chloride solution to the above mixture in Step 4. Do not agitate but let set for 5 minutes. Add this combined solution to the rotary evaporator flask containing the methanol and 25 grams of KI treated charcoal. Do not agitate;
6. Place flask on rotary evaporator; rotate at 70 RPM; set nitrogen flow at 1.0 L/min. No heat. After 10 minutes of rotation, turn heat up to 70 c. Drop receiving flask into water bath when temperature reaches 70 c; and
7. When sorbent is free flowing and free of clumps, take off flask and transfer sorbet to amber bottle. This should take roughly 1 hour. Store in freezer. Send sample for Quality Control analysis for mercury.

### This should make a mercury bulk sorbent of approximately 32,000 ng per gram of sorbent.

Various changes could be made in the above construction and method without departing from the scope of the invention as defined in the claims below. It is intended that all matter contained in the above description including the definitions and as shown in the accompanying drawings shall be interpreted as illustrative and not as a limitation.

I claim:

1. A method for making a spiked sorbent tube comprising:
a. providing a sorbent;
b. providing a tube;
c. providing a substance;
d. spiking the substance on the sorbent; and
e. adding the spiked sorbent to the tube to create a spiked sorbent tube.

2. The method as recited in claim 1 wherein the sorbent and substance are provided in bulk.

3. The method as recited in claim 2 including:
a. determining a desired concentration for the spiked sorbent;
b. selecting a desired amount of the spiked sorbent; and
c. adding additional sorbent to obtain the desired concentration of the spike sorbent.

4. The method as recited in claim 1 including providing a second substance that can be spiked onto the sorbent.

5. The method as recited in claim 1 wherein the sorbent is PCB activated carbon.

6. The method as recited in claim 1 wherein the sorbent contains carbon.

7. The method as recited in claim 1 wherein the sorbent is potassium iodide treated activated carbon.

8. The method as recited in claim 1 wherein the substance is elemental mercury.

9. The method as recited in claim 1 wherein the substance is a VOC.

10. The method as recited in claim 9 wherein the VOC contains aromatic hydrocarbons, aliphatic hydrocarbons, chlorinated hydrocarbons, esters, acetates, ethers or aldehydes.

11. The method as recited 1 where the sorbent is selected from the group of silica gel, XAD resins, Chromosorb resins, Porapak resins, Hayesep resins, porous polymer resins, carbon molecular sieves, molecular sieves, beaded carbons, or hard powdered magnesium-silica gel.

12. A method for making multiple spiked sorbent tubes comprising:
a. providing a sorbent;
b. providing a substance;
c. spiking the substance on the sorbent;
d. adding a portion of the spiked sorbent to a first tube; and
e. adding a second portion of the spiked sorbent to a second tube.

13. A method for making a spiked sorbent out of a tube comprising:
a. providing a sorbent;
b. providing a spiking substance; and
c. spiking the sorbent with the substance outside of the tube.
